(19) United States
(12) Patent Application Publication
(10) Pub. No.: US 2021/0097616 A1
(43) Pub. Date: Apr. 1, 2021

(54) RETIREMENT VISUALIZER

(71) Applicant: Wells Fargo Bank, N.A., San Francisco, CA (US)

(72) Inventors: Meghan A. Duthie, Charlotte, NC (US); Michele M. Grant, Charlotte, NC (US); Donna Edwards Peterson, Seagrove, NC (US)

(21) Appl. No.: 15/797,787

(22) Filed: Oct. 30, 2017

(51) Int. Cl. G06Q 40/06

(52) U.S. Cl. CPC G06Q 40/06; G06F 3/0482

(57) ABSTRACT

Various examples described herein are directed to systems and methods for visualizing how financial decisions having future financial impact. Financial inputs associated with a retirement. Retirement goals associated with the retirement are received. A first visualization of an item is determined based upon the retirement goals. A second visualization of an item is determined based upon the financial inputs. The first visualization item and the second visualization item are visualized in a virtual reality environment.

### BACKGROUND

As many people face retirement, there are many unknowns regarding properly saving for retirement to ensure adequate retirement income. Without pensions or other annuity type vehicles, determining a person's retirement income can be complicated and uncertain.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 is a block diagram showing a virtual reality visualization of a financial plan according to some embodiments.

FIG. 2 illustrates a virtual reality visualization of housing choices for a user according to some embodiments.

FIG. 3 is a flow diagram showing a virtual reality visualization of a retirement plan according to some embodiments.

FIG. 4 is a block diagram showing one example of a software architecture for a computing device.

FIG. 5 is a block diagram illustrating a computing device hardware architecture, within which a set or sequence of instructions can be executed to cause the hardware to perform examples of any one of the methodologies discussed herein.

### DETAILED DESCRIPTION

Planning for retirement can be daunting. Visualizing retirement, when retirement is years away, may prove difficult. Further, understanding how a financial decision today affects retirement may also be difficult to understand. Visualizing how financial decisions affect retirement or other financial goals may help a person make different financial decisions today. In an example, a user may plan for retirement and visually see how their retirement will look like based upon factors such as their goals, their current assets, current savings, planned future savings, etc. The user may also visually see how actions impact their retirement plans. For example, a user may see how saving an additional amount of money every month, for example by eating out less, provides additional retirement income. The visualizations may take the form of pictures, animated pictures, videos, etc. The visualizations may be seen in a virtual reality environment.

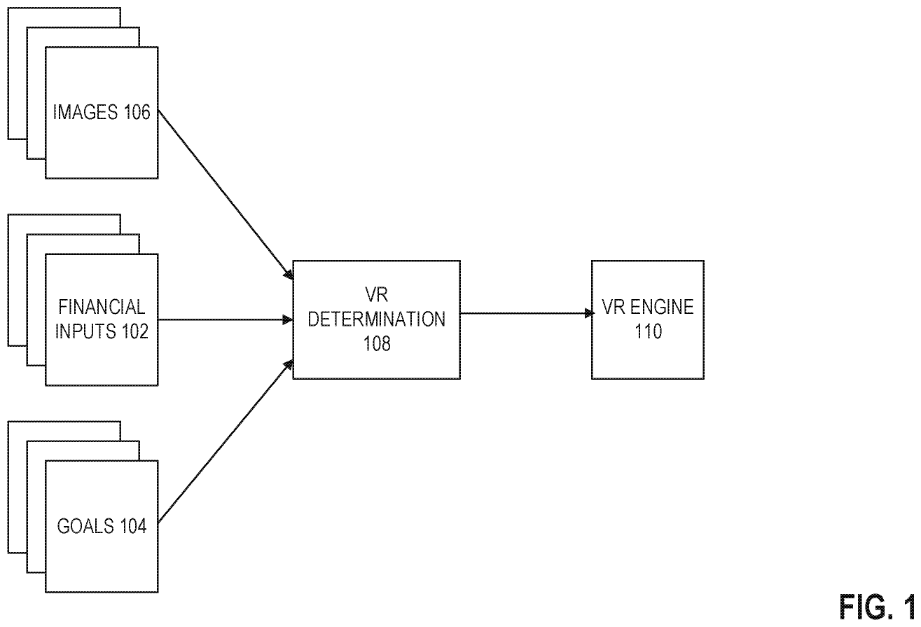

FIG. 1 is a block diagram showing a virtual reality visualization of a financial plan according to some embodiments. A user may decide to plan for retirement and desire a way to visualize what their retirement will look like. It has been shown that seeing an age enhanced photo may help a user to save more for retirement. Adding additional visualizations and interactions may help a user save even more for retirement. To start, a user may provide financial inputs 102 and goals 104 associated with retirement. For example, the financial inputs 102 may include one or more of retirement accounts, savings accounts, checking accounts, credit card accounts, planned future savings rates, future returns on investments, a retirement plan, etc. The financial inputs may be provided by receiving financial account information by a server computing system. The server computing system may then retrieve financial information such as account balances, balance history, deposits, withdrawals, etc. and store this information in a data store, such as a database.

The financial inputs 102 may be used to determine savings that the user will have for retirement. The goals 104 may include what the user would like their retirement to be like. For example, where the user would like to live, the activities the user would like to do, travel options, etc., may be part of the goals 104.

In an example, a virtual reality (VR) determination 108 engine may use the goals 104 to find one or more images from images 106 that are used to visualize one or more of the goals 104. For example, goals may include an amount of money to spend on an item, such as housing, vehicles, locations, food, etc. The expense of this item may be used to find images. For example, images of housing options may be stored along with an indication of the cost for the housing option. Images may be selected that show housing options that are in line with the goals, more expensive, or less expensive. The images 106 may be a static image, an animated image, a video clip, VR rendering, etc. For example, the image file may be a three dimensional rendering of an object, such as a house, car, vacation location, etc. The VR rendering may then provide the user with the ability to interact with the object within the VR environment. In addition, an image may have an associated audio file. The VR determination 108 may then provide the selected images to a VR engine 110. The VR engine 110 displays or visualizes the selected images for the user. The user, therefore, may see what their desired retirement looks like.

The VR determination 108 may also include analyzing the financial inputs to determine the user's estimated retirement income. This estimated income may then be compared with the retirement income needed to support the user's retirement based on the goals 104. The goals 104 may be used to calculate an estimated needed retirement income to support the provided goals 104. In an example, the estimated retirement income will not support the user's retirement based on the goals 104. For example, the estimated retirement income may not be enough to cover the costs of the user's retirement based on the goals 104. In this example, the VR determination 108 may determine cheaper options for the user's retirement.

As an example, the goals 104 may indicate the user would like to live in a single family home throughout retirement. The VR determination 108, or another component, may determine that an assisted living condo is cheaper and the estimated retirement income covers the estimated housing cost of living in the assisted living condo. The costs associated within the various options may be stored and used to determine what options the estimated retirement income covers. The VR determination 108 may select a visualization of the assisted living condo and a visualization for the single family home. For example, these visualizations may come from the images 106 database/storage. These visualizations may then be provided the visualization to the VR engine 110. The VR engine 110 may then display both the single family home visualization and the a condo visualization. The user may then visually see the differences in what they are estimated to be able to afford at retirement and what they desire.

In an example, the difference in savings needed to achieve a retirement income that supports the user's goals may be determined. This difference may be provided to the user to show how much additional savings are needed to achieve their goal. For example, the difference may be shown in the VR environment or provided via a website, application, print out, etc. In an example, the financial inputs 102 may be analyzed to determine any suggested saving opportunities. For example, an increase in 401k contributions, a rebalancing of current investments, additional savings, consumer choices, etc., may all be identified as ways to increase a user's retirement savings amount. Consumer choices may be determined from the user's spending habits. These consumer choices may be presented to the user and the user may select one or more consumer choices to save money.

The spending habits may be determined from the financial inputs. For example, a user may purchase an expensive breakfast drink every morning. A consumer choice may be purchasing a less expensive breakfast drink each morning. The savings from the choice may then be saved towards retirement. In an example, the user may elect to have the difference in cost between the more expensive breakfast drink and the less expensive breakfast drink automatically deposited into a savings or retirement account on a continual basis. For example, the amount may be deposited from one account to another user account on a daily, weekly, monthly, bi-monthly, etc., basis.

The impact of the selected consumer choice on the retirement savings may be determined. The opportunity and the opportunity's impact on the retirement income may be visualized for the user within the VR environment. In an example, a user may select one or more opportunities. In an example, the selection is done within the VR environment. The selection may also be done via an application, website, etc. Once selected, the VR determination 108 may determine how the selected opportunities affect the user's retirement income. New visualizations may then be determined and provided to the VR engine 110. For example, a user may select to purchase a less expensive car and add an additional amount of money to their retirement savings. The VR determination 108 may then determine the user may be able to afford a townhome during retirement but still not be able to afford a single family home. A townhome visualization may be provided to the VR engine 110. The user, therefore, will see how saving the additional amount of money will impact their retirement housing.

The financial inputs 102 may also be used to create a retirement budget. A user's pay checks may be part of the financial inputs 102 and be used to estimate healthcare, insurance, etc. costs. Bank statements, credit card statements, debit card statements, etc., may be used to estimate a user's spending. The user may then be able to adjust the expected retirement spending. This information may be aggregated together to form a retirement budget for the user. The retirement budget may be used by the VR determination 108 to determine if the user's projected retirement savings will be able to cover the desired retirement costs.

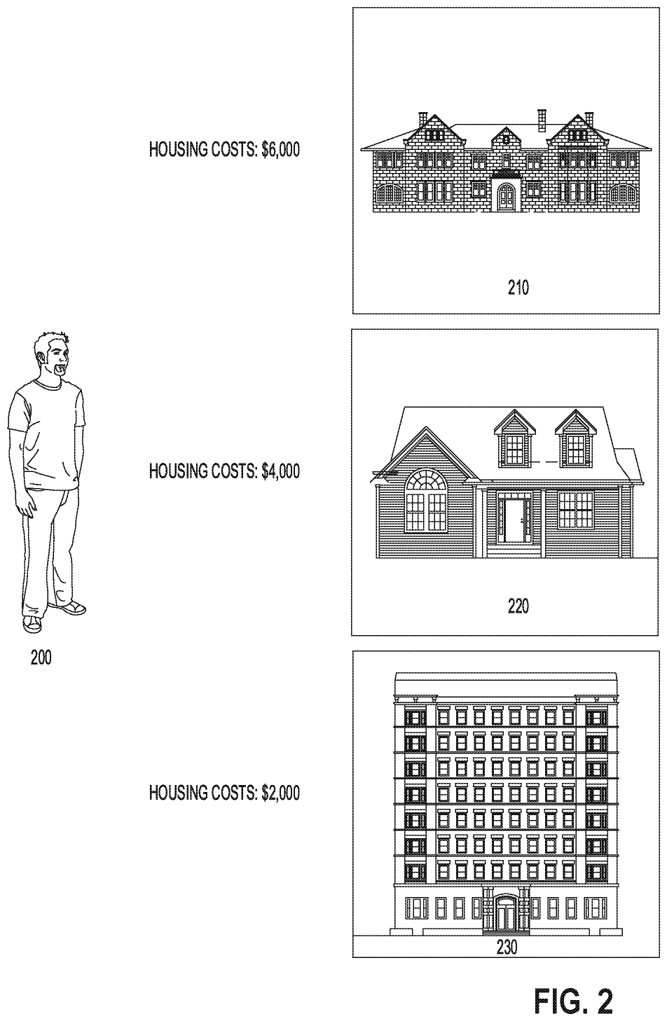

FIG. 2 illustrates a virtual reality visualization of housing choices for a user according to some embodiments. A user 200 may visualize one aspect of their retirement in a VR environment. The VR environment allows the user 200 to see and interact with the visualizations. For example, a user may be able to rotate a housing option, walk through the housing option, etc. The VR environment may also provide an input mechanism for selecting and/or changing options using user movement.

In regard to visualizations, different housing options may be presented to the user 200 to visualize various housing options. Each housing option visualization may provide the user with the ability to walk through the visualization. In addition, information regarding the cost of the various housing options may be visualized. A more expensive option 210 may be compared to a moderate option 220, and a cheaper option 230. In an example, the user 200 may select the more expensive option 210. The user's estimate retirement income may be analyzed to determine the retirement income is not enough for the more expensive option 210 and instead the cheaper option 230 is what the user 200 is estimated to be able to afford. The cheaper option 230 may then be shown as the user's current estimated housing option. A difference in the amount needed to be saved to afford the more expensive option 210 or the moderate option 220 may be provided to the user 200.

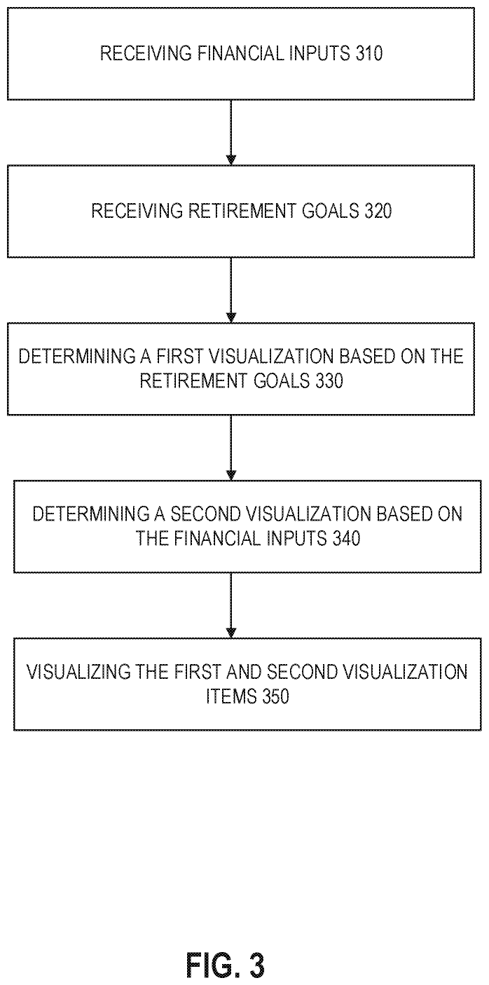

FIG. 3 is a flow diagram showing a virtual reality visualization of a retirement plan according to some embodiments. At 310, financial inputs associated with a retirement are received. The financial inputs may be information regarding savings accounts, checking accounts, retirement accounts, investment accounts, tax forms, income sources and amounts, credit card statements, spending habits, current saving amounts, planned saving amounts, etc. These financial inputs may be associated with a retirement or another financial goal. In an example, the financial inputs are associated with a user's retirement. That is, the financial inputs are planned to be used for the user's eventual retirement.

At 320, retirement goals associated with the retirement are received. The goals may be the user's desired retirement spending and plan. For example, the goals may indicate how much money the user would like to spend on travel, on housing, vehicles, food, etc. The spending amounts may be based upon a retirement budget that uses the financial inputs to provide an initial budget. The user may then adjust the budget as desired. In an example, the user indicates how they would like their retirement to look. For example, the type of home, the type of vehicle, where they live, where they travel, etc., may all be indicated without having to specify a spending amount.

At 330, a first visualization is determined based on the retirement goals. For example, a visualization that shows the type of vehicle the user would like to have during retirement may be determined. In addition, other visualizations may also be determined. For example, vacation locales, housing types, housing locations, watercraft, meals, etc., may also have visualizations.

At 340, a second visualization is determined based on the financial inputs. The second visualization may be related to the first visualization. For example, the financial inputs may be analyzed to determine the amount of expected retirement spending that may be used towards a vehicle. This amount may be more or less than the amount needed to afford a vehicle based on the user's goals. For example, the expected retirement spending may be significantly less than the user's desired vehicle. The first visualization may be an expensive automobile. The second visualization, however, may be a bicycle to indicate that the user's expected retirement income is such that the user may only be able to afford a bicycle.

At 350, the first visualization and the second visualization may be visualized in a VR environment. The user may then be able to see what they want and what they are expected to be able to afford. As noted above, seeing what their current estimated retirement income can afford may help users better plan and save for their retirement. Interacting with their various options may allow the user to see how their retirement will look and feel, rather than simply being told staticly what their retirement income may afford. The user may be able to interact with either visualization in the VR environment as known in the art.

In an example, the visualizations may be based upon determining a difference between a needed retirement income and a current retirement income. The needed retirement income may be determined using the retirement goals, while the current retirement income may be calculated based on the financial inputs. The current retirement income may be an estimate of the amount of money available to a user at retirement based upon current assets and planned savings. The needed retirement income may be an estimate of the amount of retirement income needed to achieve the retirement goals. The different between the needed retirement income and the current retirement income may be determined. This difference may be used to determine the first visualization and the second visualization. For example, a user may desire to eat out and not cook during retirement. If there is a shortage though between the needed retirement income and the current retirement income, a box of pasta representing home cooked dinners may be used as the second visualization, while an expensive looking restaurant meal may be used as the first visualization. The second visualization may be selected by determining the type of meal the current retirement income may support.

In an example, a user may visually compare their progress through a retirement plan. For example, a user may have a retirement plan that requires saving a certain amount of money each year and also an expected rate of return. The user may compare the current status with a previous status. For example, the user may compare their current status with how their retirement plan looked a year ago. The expected retirement savings and/or income for the current and previous statuses may be calculated and compared to one another. Visualizations for both may also be determined and compared. For example, one visualization may be based on the current status and a corresponding visualization may be based on the previous status. The user, therefore, is able to visualize how they are doing currently compared with the previous status.

In an example, the VR environment may be used to visualize the impact that a financial decision may have on retirement. Example decisions may include how much a user saves per month, 401K contribution levels, different types of investments, etc. Another example, is the decision to purchase a vehicle. The options for the user may be to drive their current vehicle for another year, buy a cheaper car, or buy a more expensive car. A visualization for each option may be determined. How each option impacts a current retirement income may also be calculated. For example, if a cheaper option is selected and the extra money is used toward retirement, the retirement income will increase for the cheaper option compared to a more expensive option that results in less retirement savings. The impact may be used to determine an impact visualization for each option that visualizes how each option may affect the user's retirement. For example, a housing visualization may be determined for each option and the user's goals. A more expensive car now may mean less retirement income such that the user's desired housing option is unaffordable. In this example, the housing visualization for purchasing an expensive car now may be a cheaper housing option visualization. Purchasing a cheaper car may result in a retirement income that allows the user to afford their desired housing. Waiting a year to purchase a car may result in a retirement income that has a surplus. In this example, the visualization option may be the user's housing goal with an indication that the user will have a surplus. In another example, a more expensive housing option visualization may be shown.

In an example, the financial decision may be how much money should be invested into a savings account, such as a savings account, a 401K account, or an IRA. Different deposit amounts may be provided as the various options. In an example, a selected option is received. The selected option indicates how much money should be deposited into the savings account. In addition, a frequency of the deposits may also be received. Using the frequency and the select option, automatic money transfers from another account may be setup, such that the selected amount of money is automatically deposited into the savings accounts from the other account.

The selected option may also be used to update the financial inputs. For example, selecting a more expensive item may update the financial inputs to show an increase in the user's spending for a certain period of time. The updated financial inputs may then be used to update the second visualization. In an example, the second visualization shows various options that the user may afford in retirement. When the financial inputs are updated to reflect an increase in spending, the second visualization may change to show a reduced option as the user may have less retirement income. For example, purchasing a more expensive car before retirement may negatively impact the retirement income of the user. The reduced retirement income may result in showing a reduced housing option, a cheaper vehicle, cheaper vacation options, etc. The updated second visualization may help the user see the future impact of financial decisions made prior to retirement.

In an example, a score, such as a reputation score, may be calculated for a user based upon how financial decisions are matching to the user's goals. For example, a score may increase or be better if the user's financial decisions are such that the user will achieve their retirement goals. The score may be reduced when the estimated retirement income is not enough to cover the estimated retirement costs calculated from the retirement goals.

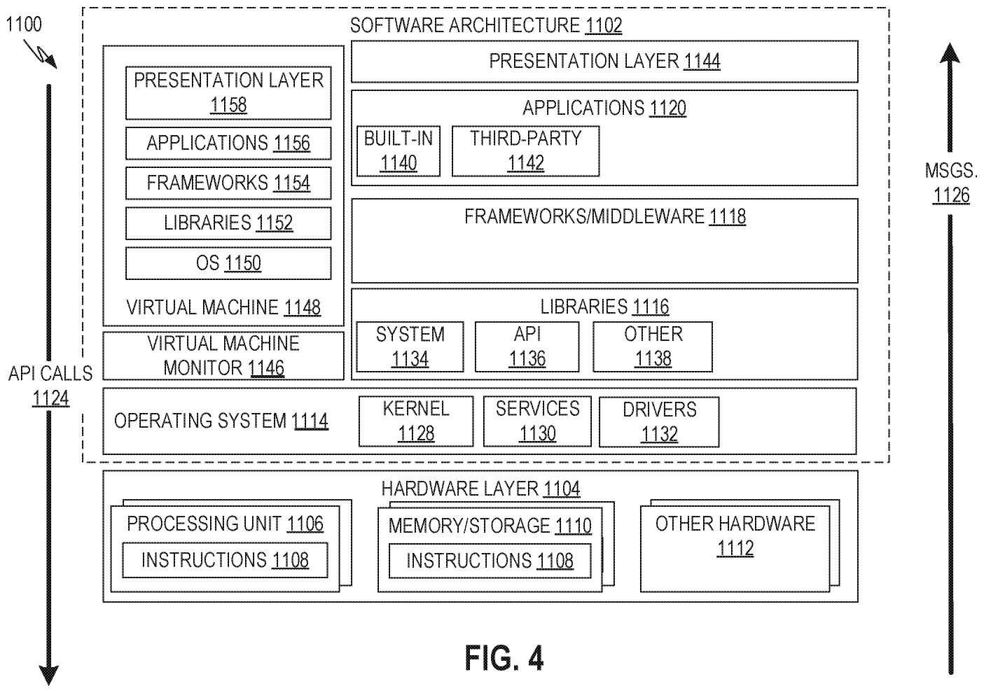

FIG. 4 is a block diagram 1100 showing one example of a software architecture 1102 for a computing device. The architecture 1102 may be used in conjunction with various hardware architectures, for example, as described herein. FIG. 4 is merely a non-limiting example of a software architecture 1102 and many other architectures may be implemented to facilitate the functionality described herein. A representative hardware layer 1104 is illustrated and can represent, for example, any of the above referenced computing devices. In some examples, the hardware layer 1104 may be implemented according to the architecture 1102 of FIG. 4.

The representative hardware layer 1104 comprises one or more processing units 1106 having associated executable instructions 1108. Executable instructions 1108 represent the executable instructions of the software architecture 1102, including implementation of the methods, modules, components, and so forth of FIGS. 1-3. Hardware layer 1104 also includes memory and/or storage modules 1110, which also have executable instructions 1108. Hardware layer 1104 may also comprise other hardware as indicated by other hardware 1112 which represents any other hardware of the hardware layer 1104, such as the other hardware illustrated as part of hardware architecture 1200.

In the example architecture of FIG. 4, the software 1102 may be conceptualized as a stack of layers where each layer provides particular functionality. For example, the software 1102 may include layers such as an operating system 1114, libraries 1116, frameworks/middleware 1118, applications 1120 and presentation layer 1144. Operationally, the applications 1120 and/or other components within the layers may invoke application programming interface (API) calls 1124 through the software stack and receive a response, returned values, and so forth illustrated as messages 1126 in response to the API calls 1124. The layers illustrated are representative in nature and not all software architectures have all layers. For example, some mobile or special purpose operating systems may not provide a frameworks/middleware layer 1118, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. In some examples, the services 1130 include an interrupt service. The interrupt service may detect the receipt of a hardware or software interrupt and, in response, cause the architecture 1102 to pause its current processing and execute an interrupt service routine (ISR) when an interrupt is received. The ISR may generate the alert, for example, as described herein.

The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1116 may provide a common infrastructure that may be utilized by the applications 1120 and/or other components and/or layers. The libraries 1116 typically provide functionality that allows other software modules to perform tasks in an easier fashion than to interface directly with the underlying operating system 1114 functionality (e.g., kernel 1128, services 1130 and/or drivers 1132). The libraries 1116 may include system 1134 libraries (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 9D in a graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks 1118 (also sometimes referred to as middleware) may provide a higher-level common infrastructure that may be utilized by the applications 1120 and/or other software components/modules. For example, the frameworks 1118 may provide various graphic user interface (GUI) functions, high-level resource management, high-level location services, and so forth. The frameworks 1118 may provide a broad spectrum of other APIs that may be utilized by the applications 1120 and/or other software components/modules, some of which may be specific to a particular operating system or platform.

The applications 1120 includes built-in applications 1140 and/or third party applications 1142. Examples of representative built-in applications 1140 may include, but are not limited to, a contacts application, a browser application, a book reader application, a location application, a media application, a messaging application, and/or a game application. Third party applications 1142 may include any of the built in applications as well as a broad assortment of other applications. In a specific example, the third party application 1142 (e.g., an application developed using the Android™ or iOS™ software development kit (SDK) by an entity other than the vendor of the particular platform) may be mobile software running on a mobile operating system such as iOS^{T1}, Android™, Windows® Phone, or other mobile computing device operating systems. In this example, the third party application 1142 may invoke the API calls 1124 provided by the mobile operating system such as operating system 1114 to facilitate functionality described herein.

The applications 1120 may utilize built in operating system functions (e.g., kernel 1128, services 1130 and/or drivers 1132), libraries (e.g., system 1134, APIs 1136, and other libraries 1138), frameworks/middleware 1118 to create user interfaces to interact with users of the system. Alternatively, or additionally, in some systems interactions with a user may occur through a presentation layer, such as presentation layer 1144. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 4, this is illustrated by virtual machine 1148. A virtual machine creates a software environment where applications/modules can execute as if they were executing on a hardware computing device. A virtual machine is hosted by a host operating system (operating system 1114) and typically, although not always, has a virtual machine monitor 1146, which manages the operation of the virtual machine as well as the interface with the host operating system (i.e., operating system 1114). A software architecture executes within the virtual machine such as an operating system 1150, libraries 1152, frameworks/middleware 1154, applications 1156 and/or presentation layer 1158. These layers of software architecture executing within the virtual machine 1148 can be the same as corresponding layers previously described or may be different.

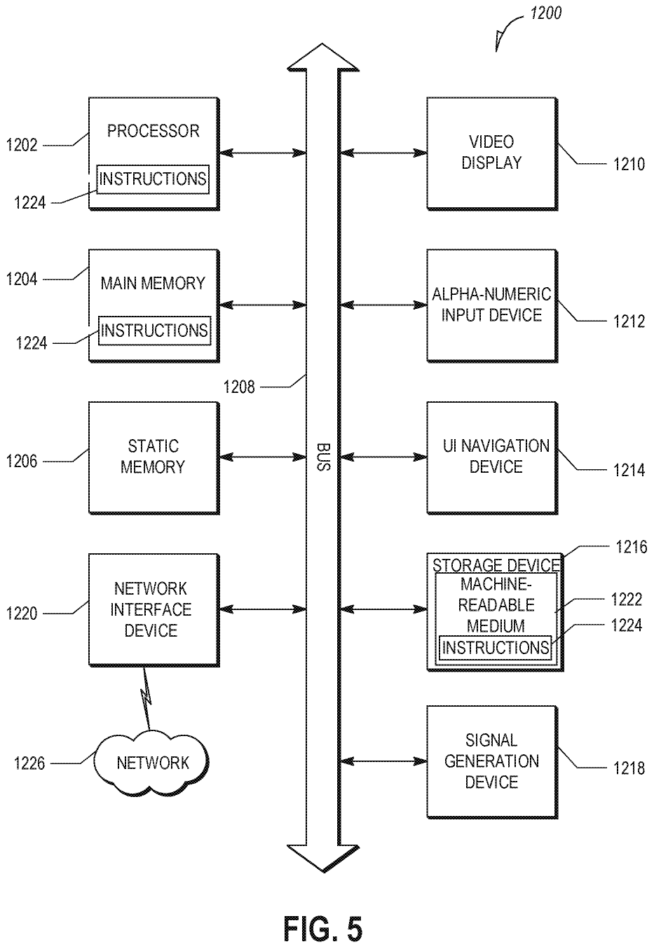

FIG. 5 is a block diagram illustrating a computing device hardware architecture 1200, within which a set or sequence of instructions can be executed to cause the machine to perform examples of any one of the methodologies discussed herein. For example, the architecture 1200 may execute the software architecture 1102 described with respect to FIG. 4. The architecture 1200 may operate as a standalone device or may be connected (e.g., networked) to other machines. In a networked deployment, the architecture 1200 may operate in the capacity of either a server or a client machine in server-client network environments, or it may act as a peer machine in peer-to-peer (or distributed) network environments. The architecture 1200 can be implemented in a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify operations to be taken by that machine.

Example architecture 1200 includes a processor unit 1202 comprising at least one processor (e.g., a central processing unit (CPU), a graphics processing unit (GPU) or both, processor cores, compute nodes, etc.). The architecture 1200 may further comprise a main memory 1204 and a static memory 1206, which communicate with each other via a link 1208 (e.g., bus). The architecture 1200 can further include a video display unit 1210, an alphanumeric input device 1212 (e.g., a keyboard), and a user interface (UI) navigation device 1214 (e.g., a mouse). In some examples, the video display unit 1210, input device 1212 and UI navigation device 1214 are incorporated into a touch screen display. The architecture 1200 may additionally include a storage device 1216 (e.g., a drive unit), a signal generation device 1218 (e.g., a speaker), a network interface device 1220, and one or more sensors (not shown), such as a global positioning system (GPS) sensor, compass, accelerometer, or other sensor.

In some examples, the processor unit 1202 or other suitable hardware component may support a hardware interrupt. In response to a hardware interrupt, the processor unit 1202 may pause its processing and execute an interrupt service routine (ISR), for example, as described herein.

The storage device 1216 includes a machine-readable medium 1222 on which is stored one or more sets of data structures and instructions 1224 (e.g., software) embodying or utilized by any one or more of the methodologies or functions described herein. The instructions 1224 can also reside, completely or at least partially, within the main memory 1204, static memory 1206, and/or within the processor 1202 during execution thereof by the architecture 1200, with the main memory 1204, static memory 1206, and the processor 1202 also constituting machine-readable media. Instructions stored at the machine-readable medium 1222 may include, for example, instructions for implementing the software architecture 1102, instructions for executing any of the features described herein, etc.

While the machine-readable medium 1222 is illustrated in an example to be a single medium, the term “machine-readable medium” can include a single medium or multiple media (e.g., a centralized or distributed database, and/or associated caches and servers) that store the one or more instructions 1224. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1224 can further be transmitted or received over a communications network 1226 using a transmission medium via the network interface device 1220 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 6G LTELTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A method comprising:
receiving, at a financial computing system, financial inputs associated with a planned retirement;
receiving, at the financial computing system, retirement goals associated with the planned retirement;
generating, at the financial computing system, a first virtual reality visualization of an item based upon the retirement goals, wherein the first visualization includes interactive elements that provide a first walkthrough environment of a first representation of the item based on the retirement goals;
generating, at the financial computing system, a second virtual reality visualization of the item based upon the financial inputs, wherein the second visualization includes interactive elements that provide a second walkthrough environment of a second representation of the item based on the financial inputs;
rendering, using virtual reality hardware, the first virtual reality visualization of the item and the second virtual reality visualization of the item in a virtual reality environment to illustrate a difference between a projected retirement based on the financial inputs and a desired retirement based on the retirement goals, wherein the virtual reality environment includes rendered controls for interacting with the first walkthrough environment and the second walkthrough environment the rendered controls including an input mechanism for selecting options using user movement within the virtual reality environment to select the options;
receiving input through the controls to adjust the financial inputs;
generating an update to the second virtual reality visualization of the item using the adjusted financial inputs; and
rendering the updated second virtual reality visualization of the item to illustrate effect of the adjusted financial inputs on the difference between the projected retirement and the desired retirement.

2. The method of claim 1, further comprising:
determining a needed retirement income based on the retirement goals;
determining a current retirement income based on the financial inputs; and
determining a difference between the needed retirement income and the current retirement income, wherein the first virtual reality visualization is based on the needed retirement income, and the second virtual reality visualization is based on the current retirement income.

3. The method of claim 1, further comprising:
determining a previous retirement income based on the financial inputs;
determining a current retirement income based on the financial inputs; and
determining a difference between the previous retirement income and the current retirement income, wherein the first virtual reality visualization is based on the previous retirement income, and the second virtual reality visualization is based on the current retirement income.

4. The method of claim 1, further comprising:
receiving a selection of a financial decision, the financial decision comprising a plurality of options;
determining a visualization for each of the plurality of options;
determining an impact on a current retirement income for each of the plurality of options;
determining an impact visualization for each of the plurality of options based on the impact; and
visualizing the impact visualization for each of the plurality of options in the virtual reality environment.

5. The method of claim 4, wherein the financial decision is a vehicle purchase, and the options are different types of vehicles.

6. The method of claim 4, wherein the financial decision is a contribution to a savings account and the options are different contribution levels.

7. The method of claim 4, wherein the financial decision is a savings amount, and the options are different saving amounts.

8. The method of claim 7, further comprising:
receiving a selected saving amount from the plurality of options; and
automatically depositing the saving amount from one account to a second account.

9. The method of claim 4, further comprising:
receiving a selected option from the plurality of options;
adjusting the financial inputs based upon the selected option; and
updating the second virtual reality visualization of the item based upon the financial inputs.

10. The method of claim 4, further comprising:
reviewing spending based upon the financial inputs;
identifying options to spend less, wherein the plurality of options are the identified options.

11. The method of claim 1, wherein the first virtual reality visualization and the second virtual reality visualization visualize one of a housing selection, housing location, watercraft, vehicle, and a vacation location.

12. A system comprising:
one or more electronic processors to execute operations comprising:
receiving financial inputs associated with a planned retirement;
receiving retirement goals associated with the planned retirement;
generating a first virtual reality visualization of an item based upon the retirement goals, wherein the first visualization includes interactive elements that provide a first walkthrough environment of a first representation of the item based on the retirement goals;
generating a second virtual reality visualization of the item based upon the financial inputs, wherein the second virtual reality visualization includes interactive elements that provide a second walkthrough environment of a second representation of the item based on the financial inputs; and
rendering the first virtual reality visualization of the item and the second virtual reality visualization of the item in a virtual reality environment to illustrate a difference between a projected retirement based on the financial inputs and a desired retirement based on the retirement goals, wherein the virtual reality environment includes rendered controls for interacting with the first walkthrough environment and the second walkthrough environment the rendered controls including an input mechanism for selecting options using user movement within the virtual reality environment to select the options;
receiving input through the controls to adjust the financial inputs;
generating an update to the second virtual reality visualization of the item using the adjusted financial inputs; and
rendering the updated second virtual reality visualization of the item to illustrate effect of the adjusted financial inputs on the difference between the projected retirement and the desired retirement.

13. The system of claim 12, the operations further comprising:
determining a needed retirement income based on the retirement goals;
determining a current retirement income based on the financial inputs; and
determining a difference between the needed retirement income and the current retirement income, wherein the first virtual reality visualization is based on the needed retirement income, and the second virtual reality visualization is based on the current retirement income.

14. The system of claim 12, the operations further comprising:
determining a previous retirement income based on the financial inputs;
determining a current retirement income based on the financial inputs; and
determining a difference between the previous retirement income and the current retirement income, wherein the first virtual reality visualization is based on the previous retirement income, and the second virtual reality visualization is based on the current retirement income.

15. The system of claim 12, the operations further comprising:
receiving a selection of a financial decision, the financial decision comprising a plurality of options;
determining a visualization for each of the plurality of options;
determining an impact on a current retirement income for each of the plurality of options;
determining an impact visualization for each of the plurality of options based on the impact; and
visualizing the impact visualization for each of the plurality of options in the virtual reality environment.

16. The system of claim 15, the operations further comprising:
receiving a selected option from the plurality of options;
adjusting the financial inputs based upon the selected option; and
updating the second virtual reality visualization of the item based upon the financial inputs.

17. The system of claim 15, the operations further comprising:
reviewing spending based upon the financial inputs; and
identifying options to spend less, wherein the plurality of options are the identified options.

18. A non-transitory machine-readable medium comprising instructions thereon that, when executed by at least one processor unit, causes the at least one processor unit to perform operations comprising:
receiving financial inputs associated with a planned retirement;
receiving retirement goals associated with the planned retirement;
generating a first virtual reality visualization of an item based upon the retirement goals, wherein the first visualization includes interactive elements that provide a first walkthrough environment of a first representation of the item based on the retirement goals;
generating a second virtual reality visualization of the item based upon the financial inputs, wherein the second visualization includes interactive elements that provide a second walkthrough environment of a second representation of the item based on the financial inputs; and
rendering the first virtual reality visualization of the item and the second virtual reality visualization of the item in a virtual reality environment to illustrate a difference between a projected retirement based on the financial inputs and a desired retirement based on the retirement goals, wherein the virtual reality environment includes rendered controls for interacting with the first walkthrough environment and the second walkthrough environment the rendered controls including an input mechanism for selecting options using user movement within the virtual reality environment to select the options;
receiving input through the controls to adjust the financial inputs;
generating an update to the second virtual reality visualization of the item using the adjusted financial inputs; and
rendering the updated second virtual reality visualization of the item to illustrate effect of the adjusted financial inputs on the difference between the projected retirement and the desired retirement.

19. The non-transitory machine-readable medium of claim 18, the operations further comprising:
determining a needed retirement income based on the retirement goals;
determining a current retirement income based on the financial inputs; and
determining a difference between the needed retirement income and the current retirement income, wherein the first virtual reality visualization is based on the needed retirement income, and the second virtual reality visualization is based on the current retirement income.

20. The non-transitory machine-readable medium of claim 18, the operations further comprising:
determining a previous retirement income based on the financial inputs;
determining a current retirement income based on the financial inputs; and
determining a difference between the previous retirement income and the current retirement income, wherein the first virtual reality visualization is based on the previous retirement income, and the second virtual reality visualization is based on the current retirement income.
